(19) United States
(12) Patent Application Publication
(10) Pub. No.: US 2026/0098628 A1
(43) Pub. Date: Apr. 9, 2026

(54) LIGHT BULB SOCKET SUPPORT INTERFACE, INTERFACE ADAPTER, AND SOCKET ADAPTER FOR LIGHT BULB SOCKET

(71) Applicant: Wintergreen Corporation, Alpharetta, GA (US)

(72) Inventors: William Hale, Cumming, GA (US); Richard Chitwood, Cumming, GA (US)

(73) Assignee: Wintergreen Corporation, Alpharetta, GA (US)

(21) Appl. No.: 19/352,751

(22) Filed: Oct. 8, 2025

Related U.S. Application Data
(60) Provisional application No. 63/704,783, filed on Oct. 8, 2024.
(60) Provisional application No. 63/708,915, filed on Oct. 18, 2024.
(60) Provisional application No. 63/854,823, filed on Jul. 31, 2025.

(51) Int. Cl. F21V 19/00; F21W 121/00

(52) U.S. Cl. CPC F21V 19/006; F21W 2121/004

(57) ABSTRACT

A light bulb socket interface assembly including a light bulb socket interface for connecting to the light bulb socket or socket adapter, A light bulb socket adapter which is employed with a light bulb socket which provides an external configuration for mating with the light bulb socket interface. A support adapter which selectively cooperates with the selected support to include a light bulb socket interface when the support does not have an integrated light bulb socket interface to cooperate with a socket and/or a socket adapter. A light bulb socket interface having more than one mating surface, and even a many as four mating surfaces, configured for receipt of light bulb socket or socket adapter enabling selective orientation and position of the light bulb socket.

### CROSS REFERENCE TO RELATED APPLICATIONS

This application claims priority to and the benefit of U.S. Provisional Application Ser. No. 63/704,783, filed Oct. 8, 2024, U.S. Provisional Application Ser. No. 63/708,915, filed Oct. 18, 2024, and U.S. Provisional Application Ser. No. 63/854,823, filed Jul. 31, 2025, each of which is entitled “Light Bulb Socket Interface, Interface Adapter, and Socket Adapter for Light Bulb Socket” and each of which is incorporated herein by reference in its entirety.

### FIELD OF INVENTION

The present invention relates generally to a light bulb socket support interface for cooperating with a light bulb socket having a mating external configuration. The invention also relates generally to a light bulb interface adapter having a support interface for cooperating with a light bulb socket having a mating external configuration. The invention also relates generally to a light bulb socket adapter for cooperating with the light bulb socket support interface and/or a light bulb socket adapter.

### BACKGROUND OF INVENTION

Decorative lights are popular for use indoors and outdoors, particularly for holidays and other celebrations. It is often desired to provide a large number of lights, such as large scale residential and commercial lighted displays, which has been proven to be time consuming to assemble. Conventional decorative lighting includes a light bulb secured in a socket wherein the socket is connected to a power source for illumination. In the context of a lighted strand of lights, many sockets are secured in various configurations along a light strand. When a lighted strand is used for decorative purposes, all or many of the individual sockets are supported by a support to achieve the desired visual result.

An individual light socket or a lighted strand of sockets and bulbs are supported in various manners. For example, it is often desired that light sockets be staked into the ground by a stake. Another exemplary application is for a lighted strand to be supported by an architectural support such as roof shingle or gutter utilizing an appropriate clip. Considering large decorative lighting installations, it is highly beneficial that there be quick and efficient installation of the light bulb sockets onto the intended supports. U.S. Pat. No. assembly 10,797,437 discloses a light socket having a mating member defined by an external configuration for securing to an attachment or support. According to the '437 patent, the light bulb socket has an external configuration on its sidewall, bottom, or distal surface, or both. The external configuration defines a channel which is generally T-shaped in that there are at least two portions having different horizontal widths. This channel may extend radially outwardly from the sidewall or bottom wall or may extend radially inwardly from the sidewall or bottom wall forming a channel. The presently disclosed invention cooperates with the light bulb sockets, such as the light bulb socket of the '437 patent having a radially inwardly extending channel on its bottom or side wall, to provide quick, effective, and efficient application of a light bulb socket to a support, particularly useful in large-scale lighting installations.

### SUMMARY OF THE INVENTION

It is, therefore, advantageous to provide a light bulb socket assembly having a light bulb socket interface for quick, effective, and stable connection with the light bulb socket to securely and firmly support the light bulb socket on the interface, such as in a decorative display. The present invention overcomes shortcomings of the prior art by providing a novel light bulb socket support having a light bulb socket interface or a socket adapter having a light bulb socket interface for cooperating with a light bulb socket having a mating external configuration or a light bulb socket adapter—and to do so in a stable manner. Moreover, the light bulb socket assembly provides versatility in lighting applications inasmuch as the light bulb socket assembly may be used in a variety of manners to orient the light bulb as desired and on various support structures for various installations. It is also an object of the present invention to provide a light bulb socket interface on a support, a support adapter cooperating with a support or a socket adapter for cooperating with a support light bulb socket interface or a support adapter, and a support for cooperating with an interface adapter thus providing a very versatile support assembly for varied and unique installations

Provided herein is a novel light bulb socket interface assembly including a light bulb socket interface for connecting to the light bulb socket or socket adapter. Also provided herein is a light bulb socket adapter which is employed with a light bulb socket, such as a conventional socket, which does not have an external configuration for mating with the light bulb socket interface disclosed herein. Also provided herein is a support adapter which selectively cooperates with the selected support to include a light bulb socket interface when the support does not have an integrated light bulb socket interface to cooperate with a socket and/or a socket adapter. Additionally provided, is a light bulb socket interface having more than one mating surface, and even at least four mating surfaces, configured for receipt of light bulb socket or socket adapter enabling selective orientation and position of the light bulb socket. These and other objectives are met by the present invention.

In some aspects, the techniques described herein relate to a support assembly for cooperating with a light bulb having a cord and light bulb socket, said support assembly including: a light bulb socket interface for cooperating with the light bulb socket, said light bulb socket interface having a mating interface including: a platform having a fore end and an aft end and a longitudinal axis; a pair of flanges extending upwardly from said platform and substantially between said platform fore end and said platform aft end, said pair of flanges defining a channel therebetween wherein said pair of flanges are each defined by a base portion extending from said platform and a rail portion extending from said base portion wherein said rail portion extends outwardly from said base portion, generally perpendicular to said longitudinal axis, so as to define an interface receiving cavity and at least one of said pair of flanges defines an aft stop defining an aft end of at least one of said interface receiving cavity; and a locking member having a fore end, said locking member extending within said channel and extending from an aft end of said channel wherein said locking member is moveable from a first position extending generally parallel to said rail portion of each of said pair of flanges to a second position which is depressed within said channel wherein said locking member fore end extends downward from said first position, wherein application of the light bulb socket engages said pair of flanges adjacent said platform fore end and depresses said locking member to move said locking member from said first position to said second position, and said interface receiving channel is configured to receive the light bulb socket when it is moved in an aft direction. Removal of the light bulb socket is achieved by reversing the direction wherein the light bulb socket is moved in the fore direction.

### BRIEF DESCRIPTION OF THE FIGURES

FIG. 1 a perspective view of a light bulb socket assembly including a light bulb interface having four mating surfaces and a support in the form of a shingle and gutter clip.

FIG. 2 is a perspective view of light bulb socket support in the form of a stake including the light bulb socket interface;

FIG. 3 is an enlarged view of the mating surface of light bulb socket interface integrated on the stake of FIG. 2;

FIG. 4 depicts a light bulb socket illustrating the socket base mounted to the light bulb socket interface on a stake;

FIG. 5 is a perspective view of a clip including the light bulb socket support interface;

FIG. 6 is a perspective view of another clip including the light bulb socket support interface;

FIG. 7 is a perspective view of the interface adapter according to another aspect of the invention to alter the direction of the light bulb socket;

FIGS. 8A and 8B and show various views of the light bulb socket adapter;

FIG. 8C is a side view of FIG. 8A;

FIG. 9 is a perspective view of light bulb socket adapter and a light bulb socket;

FIG. 10A is a perspective view of a socket interface according to another aspect of the present invention;

FIG. 10B is a rear perspective view of FIG. 10A;

FIG. 10C is a perspective view of a socket interface with a horizontally mounted light bulb socket;

FIG. 10D is a perspective view of a socket interface with a vertically mounted light bulb socket;

FIG. 11A illustrates the interface adapter and a zip tie securing member in a first position;

FIG. 11B illustrates the interface adapter and a zip tie securing member in a second position;

FIG. 12 depicts the socket adapter with a vertically positioned light bulb;

FIG. 13 depicts the socket adapter with a horizontally positioned light bulb;

FIG. 14 depicts socket support adapter having a magnet in a magnet receiving cavity;

FIG. 15 depicts a light bulb support assembly including a socket adapter and a support in the form of a clip for orienting the light bulb horizontally;

FIG. 16 depicts a light bulb socket assembly including a socket adapter and an interface adapter;

FIG. 17 depicts a light bulb socket assembly including a light bulb socket interface having two legs, each with a mating interface, connected to a support in the form of a stake;

FIG. 18 is an enlarged portion of FIG. 17 showing the mating surfaces;

FIG. 19 depicts a shingle or gutter clip having a light bulb socket interface with two legs, each with a mating interface;

FIG. 20 depicts another view of FIG. 19;

FIG. 21 depicts a two piece interface adapter having two legs, similarly configured, removably and pivotally connected wherein the interface adapter selectively is used with one or two legs;

FIG. 22 is an enlarged view of a portion of the interface adapter of FIG. 21;

FIG. 23 shows an extended interface adapter of FIG. 21;

FIGS. 24A, 24B, 24C and 24D are perspective views of the light bulb socket support interface having two legs, each leg having mating surface on opposing sides and for supporting a light bulb socket in various exemplary directional positions;

FIGS. 25A, 25B, 25C, 25D, 25E, 25F, and 25G are perspective views of the light bulb socket support interface having two legs, each leg having mating surface on opposing sides and for supporting three light bulb sockets in various exemplary directional orientations;

FIGS. 26A, 26B, and 26C are perspective views of the light bulb socket support interface with an aperture for receipt of a screw for screw attachment;

FIGS. 27A and 27B are perspective views of a socket interface used with a support adapter showing the socket support in two positions;

FIGS. 27C and 27D are perspective views of a socket interface used with a support adapter connected to a stake and showing the socket support in two positions;

FIGS. 28A and 28B illustrate a light bulb socket in two different orientations on the socket support of FIGS. 27C and 27D;

FIG. 28C is a perspective view of connection members on a stake for cooperating with the socket interface of various Figures;

FIG. 28D shows a stake according to FIG. 28C;

FIGS. 29A and 29B illustrate the support adapter supported on a clip that fastens on the ridge of a roof utilizing shingles to cooperate with flanges or on a gutter screen, the Figures illustrating different socket adapter orientations;

FIG. 30 illustrates a support for cooperating with the light bulb socket interface in the form of a shingle clip;

FIG. 31 illustrates another support for cooperating with the light bulb socket interface in the form of a shingle clip;

FIGS. 32A and 32B illustrate different views of the support adapter according to one aspect of the present invention;

FIGS. 33A, 33B, and 33C illustrate different views of a light bulb socket support in the form of a gutter and shingle clip according to one aspect of the present invention; and

FIGS. 34A and 34B illustrate a perspective and side view, respectively, of a socket adapter having a mating surface for supporting a hanging or downward facing light bulb socket or socket adapter.

### DETAILED DESCRIPTION OF THE INVENTION

The present invention is understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise.

Ranges can be expressed herein as from “about” one particular value, and/or to “about” another particular value. When such a range is expressed, another aspect includes from one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” and “selective” or “selectively” mean that the subsequently described event or circumstance may or may not occur, and that the description includes instances where said event or circumstance occurs and instances where it does not. For the purposes of describing and defining the present invention it is noted that the use of relative terms, such as “substantially”, “generally”, “approximately”, and the like, are utilized herein to represent an inherent degree of uncertainty that is attributed to any quantitative comparison, value, measurement, or other representation. These terms are also utilized herein to represent the degree by which a quantitative representation may vary from a stated reference without resulting in a change in the basic function of the subject matter at issue. The terms “fore” and “aft” used herein refer to directions that are different from one another. For example, the forward direction of the figure and the rearward direction of the figure.

As used herein, a light bulb socket “support” refers to any support for stabilizing or mounting a light bulb socket to a desired surface including, the ground or an architectural structure (e.g., house or building). While not limited to these examples, a support used herein includes a ground stake, a gutter clip, a shingle clip, a magnetized mount, an adhesive mount, a permanently secured mount, etc. “Support” as used herein refers collectively to any structure or method of mounting, stabilizing, or supporting a light bulb and socket and aspect shown and described regarding one form of support means that other supports may be interchanged without departing from the spirit and scope of the invention. For the sake of discussion and illustration, a light bulb socket assembly wherein the support for the light bulb includes the mating interface to mate with a socket having a mating external configuration is shown and described. It is within the scope of the invention, however, to reverse these wherein the mating interface is on the socket to mate with an external configuration of the support or support adapter.

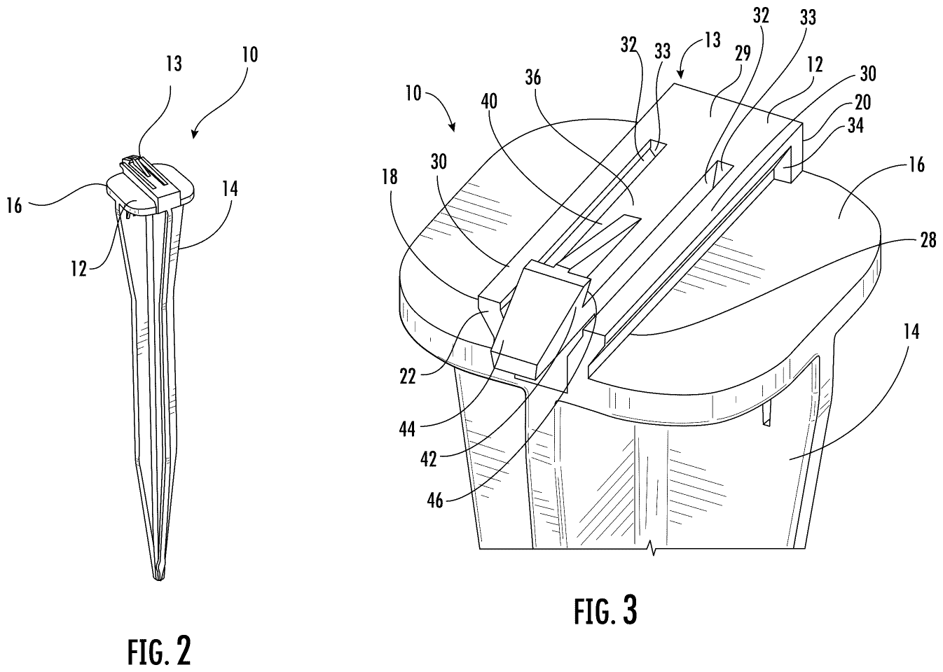

FIG. 2 illustrates a light bulb socket support assembly 10 including a support shown as a stake 14 and including a light bulb socket interface 12 including a platform 16 and a mating interface 13. It is within the scope of the present invention, however that the light bulb socket support assembly 10 is mounted to any surface for supporting a light bulb, either directly or indirectly. As shown in FIGS. 2 and 3, the light bulb socket interface 12 is integrated with a top surface of a stake 14. As best shown in FIG. 3, the mating interface 12 includes a first insertion fore end 18, a second aft end 20, and has a longitudinal axis extending generally perpendicular to the platform 16 (or parallel to the stake as shown in FIG. 3).

The insertion end 18 of the mating interface 13 includes a fore face 22 defining a surface configuration for receiving a light bulb socket mating member 26. The light bulb socket interface includes at least one flange or a pair of flanges (as shown) extending upwardly from the stake top surface. Each flange is defined by a base portion 28 extending upwardly from platform 16 as shown in FIG. 3. Each flange further includes a rail portion 30. Rail portion 30 has a width greater than the width of the base portion 28 (measured in a direction generally perpendicular to the socket interface 12 longitudinal axis) to extend outwardly beyond the outer side of the base portion 28. The inwardly facing surface of the flanges comprising the base portion 28 and the rail portion 30 define an interface channel 32. The interface channel 32 includes an open end adjacent to the insertion fore end 18 and an aft wall 33.

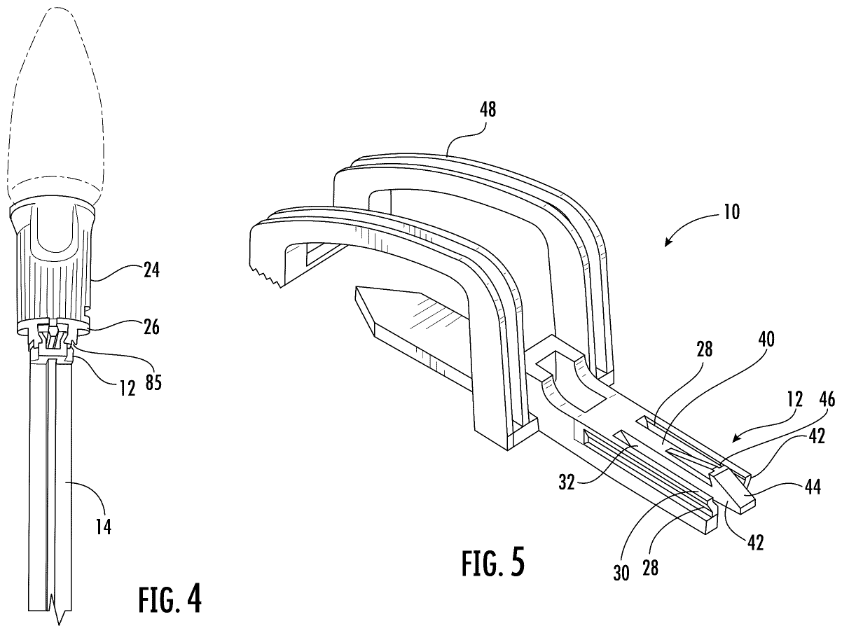

As shown in FIG. 4, the light bulb socket mating member 26 is inserted over the fore face 22 of the light bulb socket interface 12 and the light bulb socket 24 is slidingly advanced across the light bulb socket interface 12 until abutting the second aft end 20. The second aft end 20 includes at least one stop 34 or more than one stop 34 configured to engage the light bulb socket mating member 26 and to serve as a stop once the light bulb socket 24 is fully advanced along the mating interface 13. It is within the scope of the present invention to reverse the mating members wherein the light bulb socket mating member 26 configuration is on the light bulb socket support assembly 10 and wherein the light bulb socket interface 12 configuration is on the light bulb socket 24. For the sake of discussion, reference is made to the arrangement shown in FIGS. 2 and 3. It is within the scope of the present invention, however that the light bulb socket mating member 26 is mounted to any surface for cooperating with an interface, either directly or indirectly. As shown, the light bulb socket interface 12 and the light bulb socket mating member 26 are horizontal, but other orientations are incorporated herein.

A locking member 36, according to one aspect of the invention, includes a flange 40 which is cantilevered and extends from platform 29. Flange 40 is not supported by base 28 and is, thus, moveable vertically between adjacent bases 28 as best shown in FIG. 3. A lock 42 is positioned adjacent to the fore end of the flange 40. The lock 42 includes a sloped fore end 44 configured for cooperating with light bulb socket mating member 26. Thus, when the light bulb socket mating member 26 is inserted over light bulb support interface 12, it engages with the interface receiving channel 32 and the sloped fore end 44 of the locking member 36 and depresses the locking member 36 including the locking member 42 and flange 40. Upon depression of the lock 42, the light bulb socket interface 12 is fully applied, such as by sliding, along the light bulb socket interface 12 until engaging the stop 34 on the second aft end 20 of the light bulb socket interface 12. Upon being fully inserted along the support interface 12, while not being bound by any particular theory, the locking member 36 reverts back to its original, non-depressed, position and the lock aft end 46 abuts the light bulb socket support assembly 10, securing it on the light bulb socket support interface 12. The light bulb socket 24 may be removed by depression of the locking member 36, thus permitting sliding in the fore direction. It is within the scope of the present invention to provide a light bulb socket support assembly 10 which does not include a locking member.

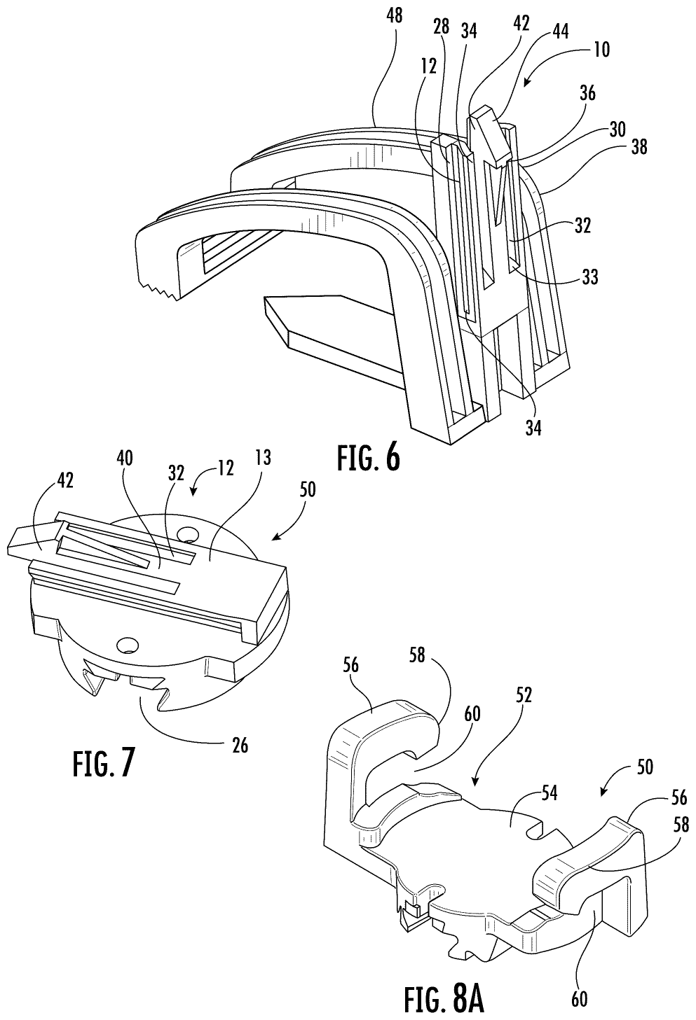

FIGS. 2-4 illustrate the light bulb socket support assembly 10 according to the present invention wherein the support interface 12 is integrated with light bulb socket support assembly 10 in the form of a stake 14. This is by way of example and the light bulb socket interface 12 may be integrated or otherwise secured to other forms of supports. For example, FIGS. 5 and 6 show two variations of gutter or shingle clips 48. The clip 48 includes a light bulb socket support interface 12 as described above regarding FIGS. 2-4. More specifically, the light socket support interface 12 includes base 28 and rails 30 defining an interface receiving channel 32. Locking member 36 includes a lock 42 which extends on the fore end of flange 40 as described above. While a clip 48 and stake 14 are shown and described, it is within the scope of the present invention that various other supports assembly 10 for supporting a light bulb socket support interface 12 fall within the scope of the present invention.

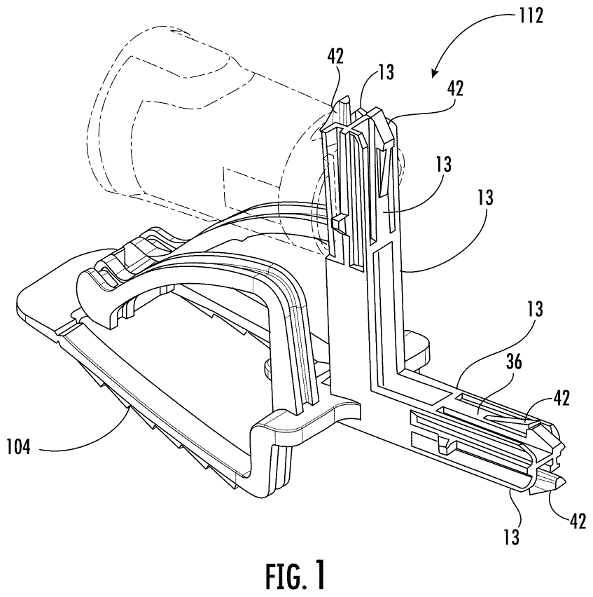

A novel aspect of the present invention is the versatility of the light bulb socket interface 12. As described regarding FIGS. 2-4, the light bulb socket interface 12 is affixed to a support (in the form of a stake as shown). The light bulb socket interface 12 is utilized on other supports as described herein by way of example. FIGS. 5 and 6 illustrate the light bulb socket interface 12 on various clips, such as gutter or shingle clip. According to any aspects of the present invention, the light bulb socket interface 12 is also provided in combination with more than one light bulb socket interface 12. More than one light bulb socket interface 12 is shown by way of example in FIG. 1 wherein four bulb socket interfaces 12 are provided for use with a single support assembly. As shown in various Figures, any number are provided on various supports while two and four light bulb socket interfaces 12 are shown as exemplary. Similarly, the socket adapter 70/70′ is shown with one or two light bulb socket interfaces 12, by way of example. The combination of supports, adapters, and lighting directions are numerous (too numerous to explicitly list) according to the instant invention.

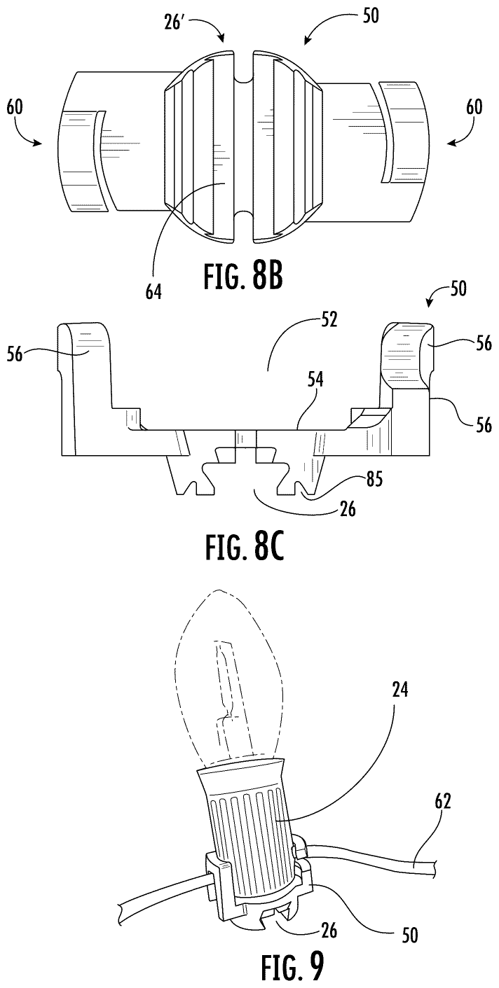

FIG. 4 illustrates a light bulb socket 24 having a light bulb socket mating member 26 to cooperate with the light bulb socket support interface 12. The versatility of the present invention is further exemplified in that it is also compatible with conventional light bulb sockets that do not have an integrated external configuration to mate with the light bulb socket interface 12. Therefore, another aspect of the support assembly for a light bulb according to the present invention includes light bulb socket adapter 50. This permits conventional light bulb sockets to be used with the light bulb socket supports assembly 10 that includes an integrated interface 12 or a support having a secured light bulb socket interface 12 (including with the interface adapter 70/70′ described below). As shown in FIG. 9, a conventional light bulb socket 24, not including an external configuration having a light bulb socket mating member, is used with a socket adapter 50 which, in turn, cooperates with light bulb socket interface 12 as described herein. As shown in FIGS. 8A, 8B and 8C, the socket adapter 50 includes a first face or side defining a light bulb socket receiving cavity 52 having a socket seat 54 and side arms 56. The receiving cavity 52 is configured to receive the light bulb socket as shown in FIG. 9. The side arms 56 include a clip 58 having an opening 60 within which a light strand 62 is received as shown. See FIG. 9. The light strand 62 cooperating with the side arms 56 secures the light bulb socket 24 within the socket adapter 50. As shown, the side arms 56 are facing opposing directions to secure the light strand 62 from a light bulb socket 24 to prevent unintentional dislodgement wherein the openings 60 face opposite directions.

The opposing side of the socket adapter 50, as shown in FIG. 8B, includes a light bulb socket mating member 26′ configured to cooperate with a light bulb socket support interface 12 such as on a stake 14 (FIG. 2), a clip 48 (FIGS. 5 and 6), or interface adapters 70/70′ (FIGS. 7, 9, 10 and 34). The light bulb socket mating member 26′ includes a channel configured for receipt of a light bulb socket support interface 12.

According to another aspect of the present invention, the socket adapter 50 includes at least one, or a pair of stop channels 85 as shown in the socket adapter 50 of FIG. 8C and which is also provided on the socket mating member 26 of a socket mating member 26 of a socket shown. At least one, or as shown a pair of stops 80 extend outwardly from side edges of the leg 71/73 of the socket interface 12 as shown in FIGS. 33A, 33B, 33C,26A and 26C. These features facilitate use of the light socket support assembly 10 with various sized sockets 24 or socket adapters 50 to prevent a loose connection therebetween. For example, for a mating member 26 which is smaller, the stops 80 would limit movement and secure the position of the socket or adapter prior to further aft movement wherein the stop 34 is encountered. For larger mating member configurations, the stop channels 85 facilitate movement over the stops 80, permitting contact with the stops 34 (that is, full aft movement).

FIG. 7 illustrates a support adapter 50 for use with a light bulb having light bulb socket mating member 26 on one side and a light bulb support interface 12 on the other side. Notably, the support adapter 50 changes the orientation of the light bulb socket 24 mounted thereto. For example, instead of running generally perpendicular to the light bulb socket mating member 26′ as shown in FIGS. 6B and 7, it may extend at any angular orientation relative thereto. Thus, the orientation of the light bulb support interface 12 is selective.

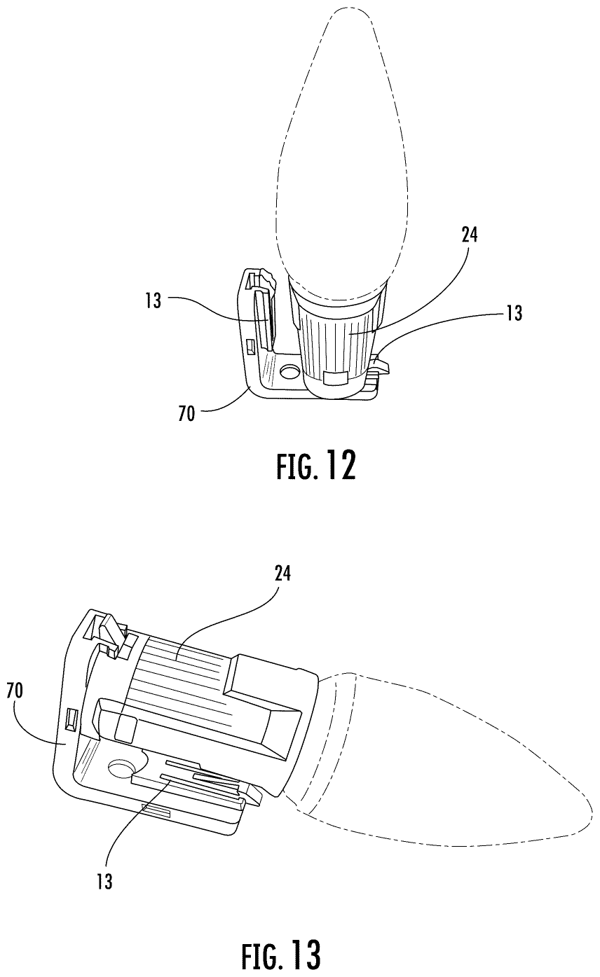

According to another aspect of the present invention, a socket adapter 70 is provided to facilitate use with supports that do not include an integrated light bulb socket interface 12. As shown in Figures assembly 10A-14 and 16, a generally L-shaped light bulb socket support adapter 70 includes a first leg 71 having a mating interface 13 and a second leg 73, generally perpendicular to the first leg 71, also having a mating interface 15. As shown, the legs are generally perpendicular, but they may extend from any predetermined angle relative to one another. This enables two mating interfaces 13 providing selective positioning of the light bulb socket 24.The mating interfaces 13 include rails 30 and locking member 36 for selectively mating with a light bulb socket mating member 26 or socket adapter 50 used with a light bulb socket 24 as described above. Providing two the mating interface 13 in a generally L-shaped configuration, thus, enables optionality with light bulb socket 24 placement. As shown in FIG. 12, the light bulb socket 24 and light bulb are vertically arranged as the light bulb socket 24 is positioned on the horizontal leg 71/73. As shown in FIG. 13, the light bulb socket 24 and light bulb are horizontally arranged and positioned on the vertical leg 71/73. This provides selectivity in light bulb socket 24 and light bulb positioning for particular light installations.

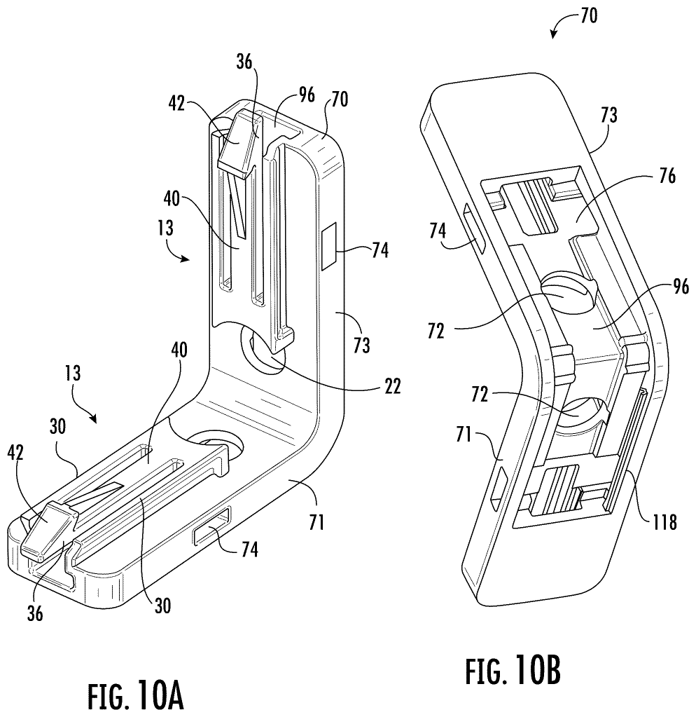

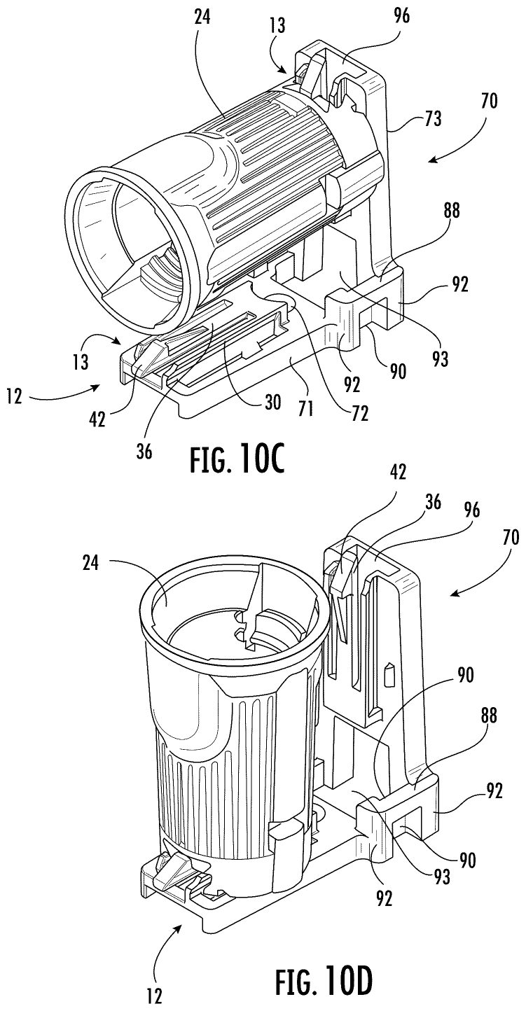

As shown in FIGS. 10A and 10B, the support adapter 70 includes two mating interface 13 on a generally L-shaped bracket wherein each leg includes a mating interface 13. The support adapter 70 may be secured to numerous supports for cooperating with a light bulb socket 24 having a light bulb socket mating member 26 or a light bulb socket 24 having a support adapter 50. FIGS. 10C and 10D depict the light bulb socket support assembly 10 with two mating interfaces 13 wherein a socket 24 is supported horizontally (FIG. 10C) or, selectively, vertically (FIG. 10D).

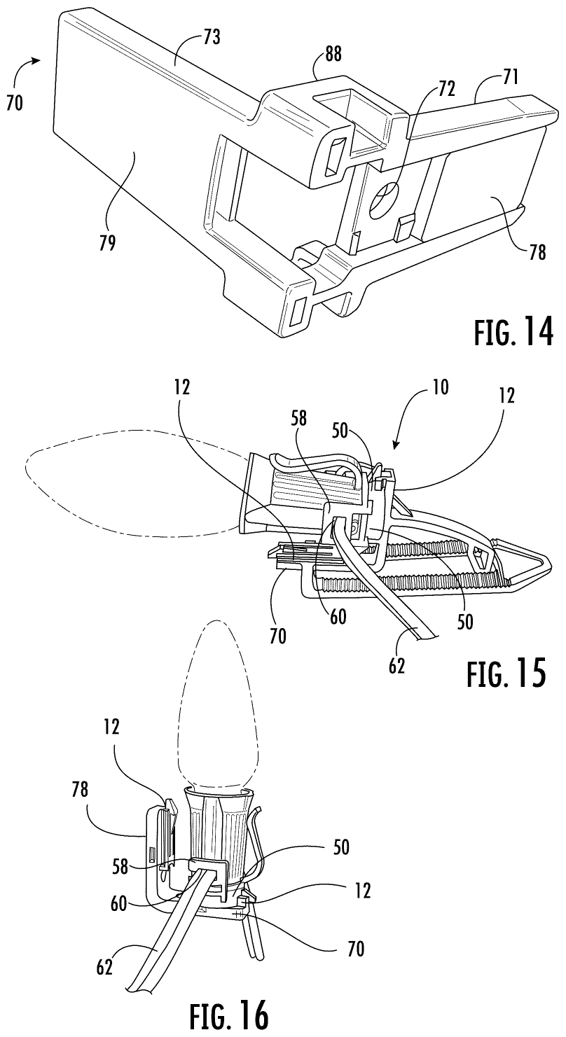

The support adapter 70 shown in FIGS. 10A and 10B provides versatility in that the support adapter 70 is used with any support, including by a strap or tie, screw, adhesive, or magnet, for example. Holes 72 are provided on at least one, or as shown, each leg of the support adapter 70 which are configured for receipt of conventional securing members, such as a screw or nail. Additionally, and selectively, at least one, or as shown, each leg of the support adapter 70 defines apertures 74 on side edges configured for receipt of a linear connection member such as a tie, strap, or wire. Additionally, and selectively, at least one, or as shown in FIG. 10B, each leg of the socket support adapter 70 defines a magnet receiving cavity 76 configured for receipt of a magnet 78 as shown in FIGS. 14 and 16 (shown to be magnetized to a metal structure). Alternatively, other attaching methods such as hook/loop material or adhesive may be employed. As shown in FIG. 14, a flat surface 79 provides a surface for receiving an adhesive material. The magnet receiving cavity 78 shown is also utilized, according to other aspects, for receipt of any connection member, even non-magnetic members. As shown in FIG. 10B, a ledge118 (at least one or a pair on opposing cavity sides) provides further support for the magnet 78.

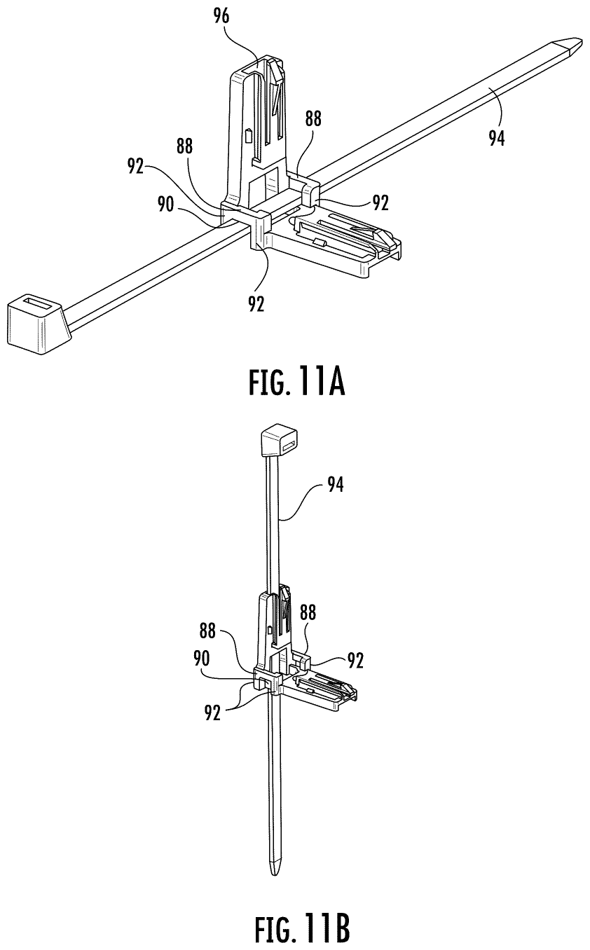

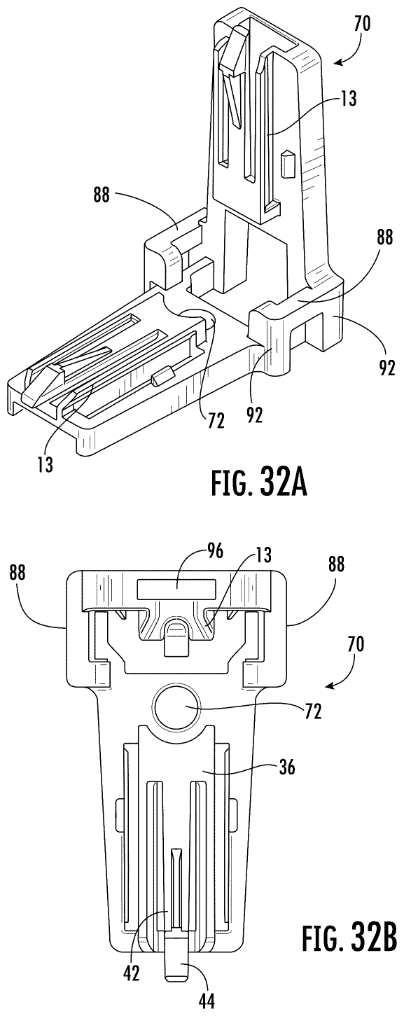

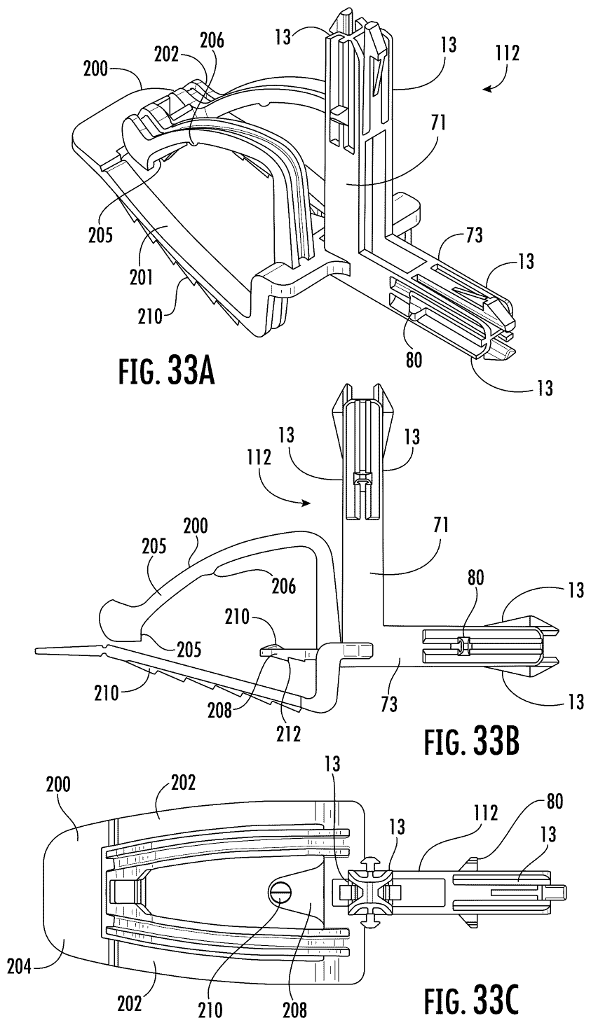

As shown in Figures assembly 10C and assembly 10D, support adapter 70 is differently configured. Notably, the first 71 and second 73 legs are each connected by an intermediate member, arm 88, one each of opposite sides of the support adapter 70. An open area 93 is defined at the intersection of the 71 and second 73 legs, between the arms 88. According to another aspect of the present invention shown in FIGS. 11A and 11B, the arm 88 is defined by perpendicular members 92 with arm 88 extending therebetween. The perpendicular members 92 and arm 88 define an aperture 90. The aperture 90 is configured for receipt of securing member, such as a strap-like member or zip tie 94 as shown in FIG. 11A. The arm 88 is also shown in FIG. 32 in different profile images.

According to another aspect of the present invention, the light bulb socket support assembly 10 includes a securing channel 96 which extends behind the locking member 36 of the mating interface 13 as shown in FIGS. 10A, 10B, 10C and 10D. As shown in FIG. 10B, securing channel 96 is configured for receipt of a vertically oriented zip tie 94, thus adding to the versatility of the light bulb socket support assembly 10 for varying installations. According to one aspect, the securing channel 96 may be defined by the magnet receiving cavity 76 described above.

FIG. 15 illustrates the socket adapter 50 (as shown in FIG. 8A) integrated with a shingle clip, demonstrating one of numerous types of supports which is used with the light bulb socket assembly 10 according to the present invention. Moreover, various features shown and described are combined in a light bulb socket assembly 10 such as shown in FIGS. 15 and 16 wherein the socket adapter 70 utilizes a magnet cavity 76 on a vertical leg of the socket adapter 70 and a socket adapter 50 is used in combination with the support adapter 70. Numerous variations are possible and envisioned within the scope of the present invention.

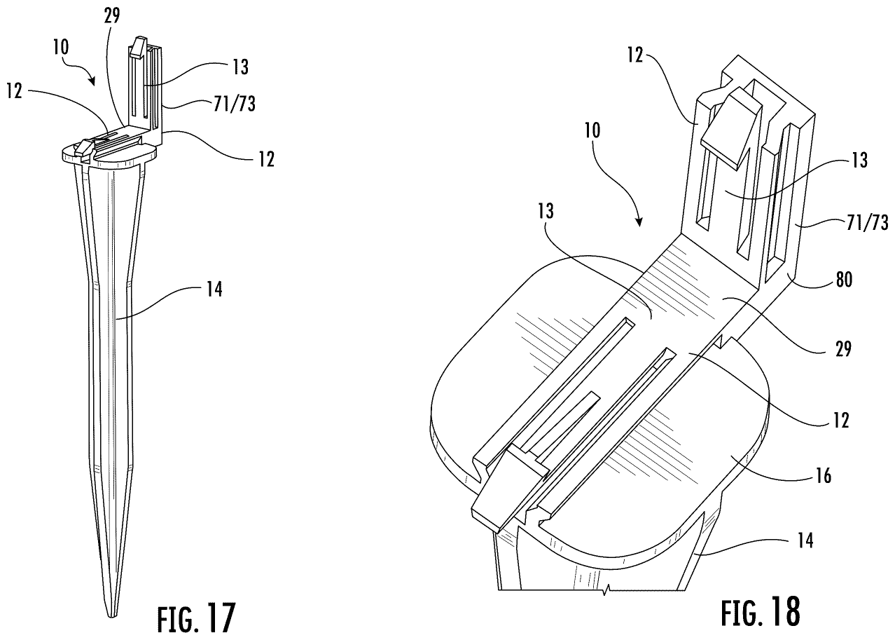

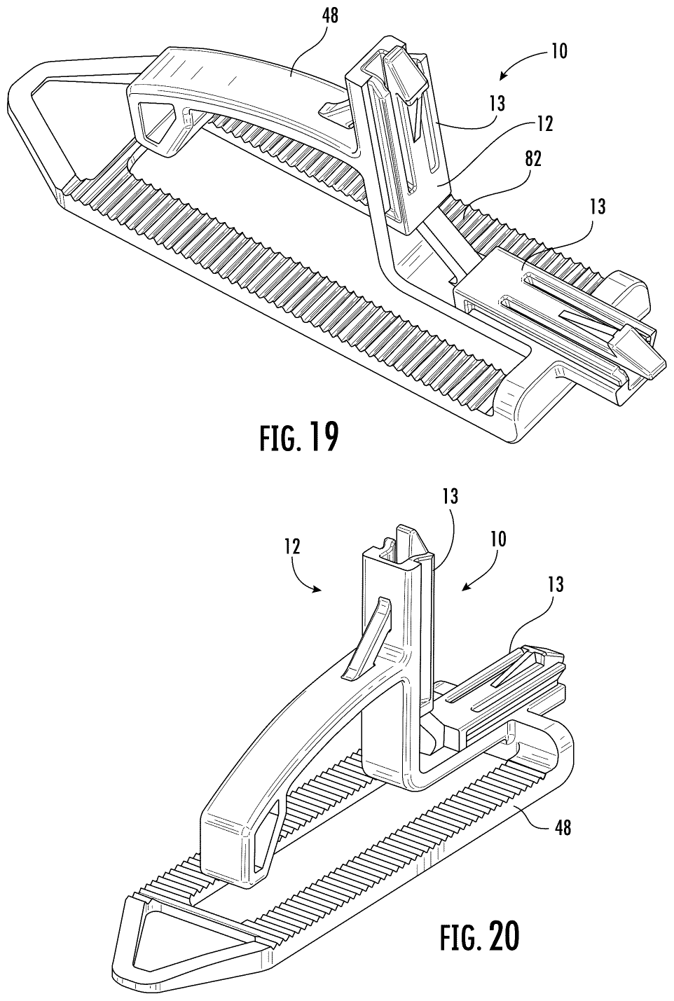

The support adapter 70 described above is removably connected to the desired support in a variety of manners. According to other aspects of the present invention, as shown in FIGS. 17, 18, 19 and 20, the support adapter 70 is integrated to the respective support. The light bulb socket interface 12 is in the form of the support adapter 70 shown in FIGS. 17-18, but which is secured (that is, not as readily removeable as other socket adapters) to a support in the form of a stake 14. The light bulb socket support assembly 10 includes a generally vertical leg 71/73 which extends generally perpendicular to the platform 29 of the horizontally extending socket support interface 12. The leg 71/73 supports the vertically extending mating interface 13.. The support adapter 70 shown in FIGS. 19-20 is secured to a shingle clip 48. Alternatively (not shown), compared to other aspects of the present invention, the legs 71/73 are not directly connected but, instead are each secured to the support (clip 48).

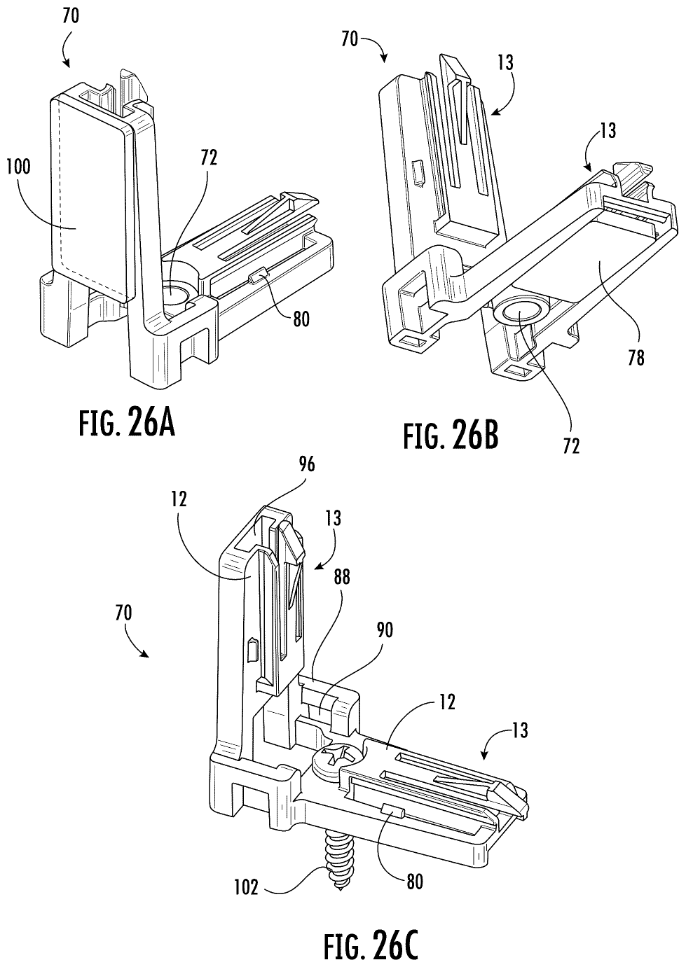

The support adapter 70 disclosed herein is highly versatile in different settings enabling different manners of connecting the socket adapter 70 to the support. FIGS. 26A-C illustrate the light bulb socket support assembly 10 having two mating surfaces 13 in the form of a generally L-shaped bracket described above, including an aperture 72 configured for receipt of a screw 102 for securing to a support. On the rear side of the light bulb socket interfaces 13, according to the aspect of the invention shown in FIG. 26A a, there is a cavity for receipt of mechanical securing member having a contact surface 100 for cooperating with a support. The contact surface 100, by way of example, provides a surface for adhesive, contact tape or Velcro®. Shown in FIG. 26B, a magnet 78 is also provided, albeit the rear side of this leg also is a contact surface without departing from this inventive concept.

It is within the scope of the present invention that the socket support assembly 10 having two light mating surfaces 13 is used with a socket adapter 50 which is employed with various light bulb socket supports 14, in addition to a stake 14. For example, FIGS. 19 and 20 illustrate the socket support assembly 10 having two mating interface 13 integrated or otherwise secured to a gutter or shingle clip 48. The light bulb socket support assembly 10 includes an arm 82 extending angularly between the mating interface 13 The vertically extending mating interface 13 as shown extends generally perpendicular to the horizontally extending socket support interface 12. Other angular orientations are envisioned.

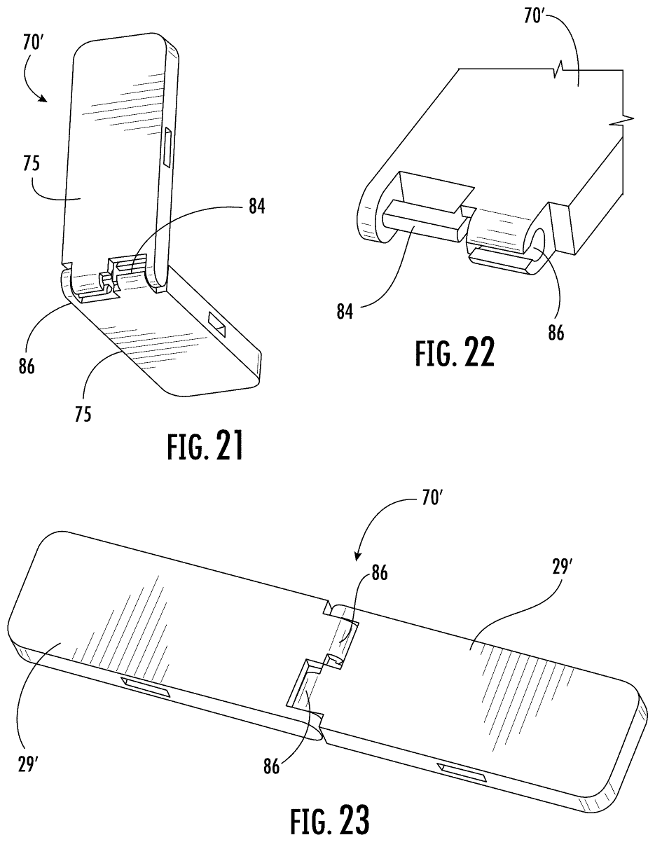

According to another aspect of the present invention shown in FIGS. 21-23, the support adapter 70′ is a two-piece bracket wherein the legs 75 (similar to 71/73) are pivotally connected. The socket support 70′ includes two legs 75 each for supporting a respective mating interface 13. The legs 75 are removably connected to one another according to one aspect of the present invention and are pivotally connected according to another aspect. FIG. 21 depicts legs 75 positioned generally perpendicular to one another and FIG. 23 depicts the legs 75 extended linearly, in a compact, partially folded position. The legs are removably connected and, accordingly, one or both legs may selectively be utilized depending upon the light display requirements. FIG. 22 is an exemplary depiction of a connection between the two legs 75 wherein a bar 84 and barrel 86 selectively connect adjacent legs and, according to one aspect, permit a pivotal connection therebetween. Although not shown, it is within the scope of the present invention to provide a mating interface on one side of each leg 75 and a light bulb socket interface on the other side of each leg 75. Thus, the support adapter 70′ cooperates with a support using connection members described above in connection with the interface adapter 70.

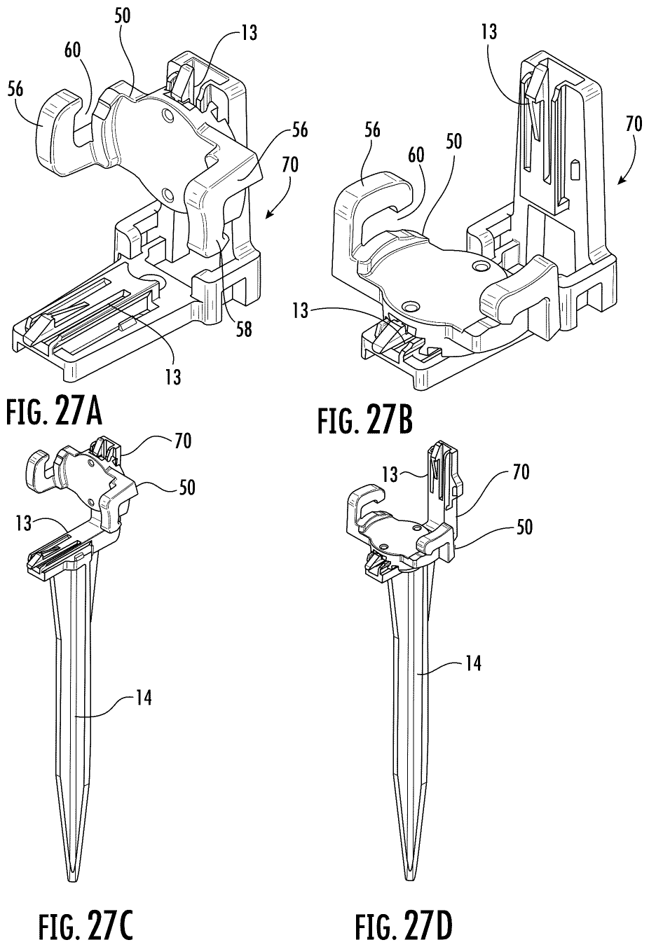

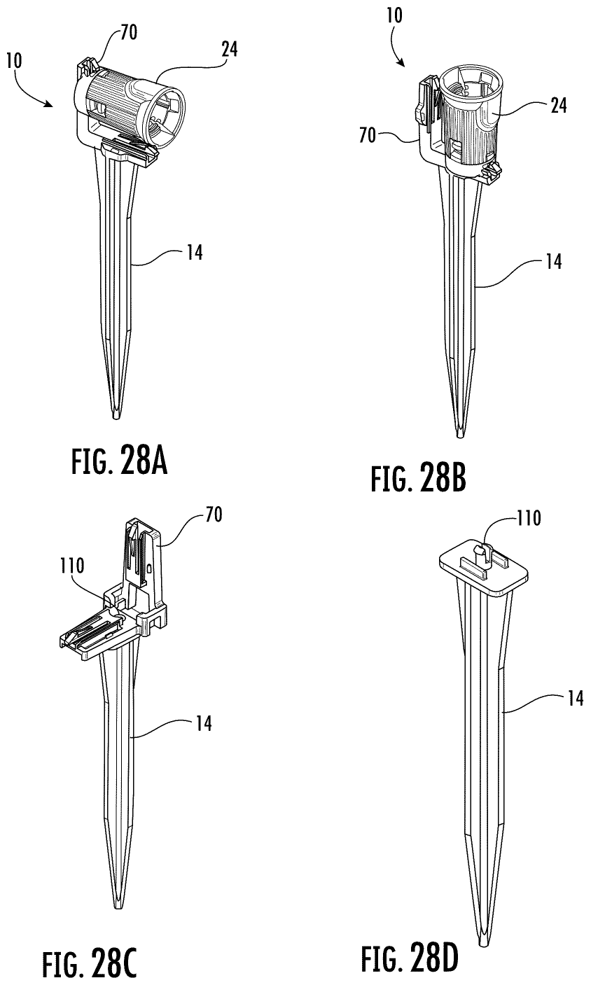

Similarly, the versatility of the socket adapter 50 is illustrated, for example, in FIGS. 27A-27D. The support adapter 70 is selectively used in connection with a light bulb socket 24 having a light bulb socket mating member 26 or a socket adapter 50, and with various connection members (strap, screw, magnet, etc.). According to any of the above-described socket supports 70/70′, the adapter 50 is compatible with all configurations. For example, FIG. 27A depicts the adapter 50 positioned on the vertical arm of the support interface adapter 70 shown in FIGS. 10A-11B, 12, 13 26A-C, and 27A depict the adapter 50 positioned on the horizontal arm of the socket adapter 70 including a magnet cavity 76. FIGS. 28C and 28D depict the socket adapter 50 used in connection with light socket support interface 12 secured to a stake as shown in FIG. 17 and further illustrates the adjustably of the direction of the light bulb. This provides adaptability of the light bulb socket support assembly 10 to support a conventional light bulb socket 24 in a vertical (FIG. 27C) or horizontal (FIG. 27D) orientation.

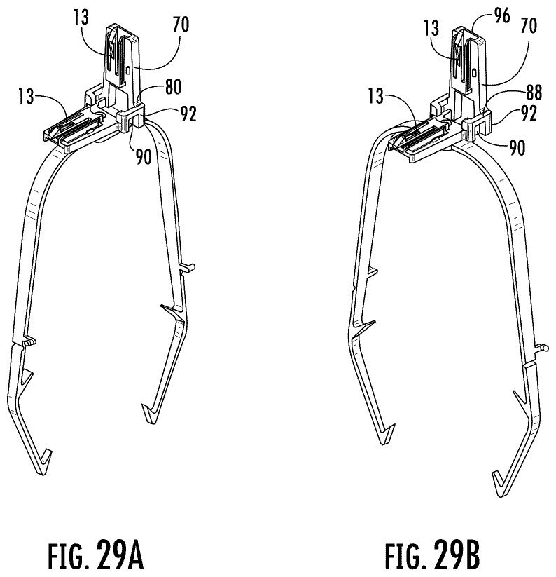

According to various aspects described above, the interface adapter 70 cooperates with any structural support including a stake as shown in FIGS. 27C and 27D. By way of another example, FIGS. 29A and 29B illustrate the socket support adapter 70 supported on a clip that fastens on the ridge of a roof utilizing shingles to cooperate with flanges. The clip includes at least one, or as shown, two inwardly facing spikes adjacent to the lower end of the clip and at least one or, as shown two, upper flanges configured to connect to a gutter screen. Also shown is a score line for easy breakage of the bottom portion of the clip if it is not needed. These Figures illustrate, particularly, that the orientation of interface adapter 70 is variable. For example, in FIG. 29A, the orientation of the interface adapter 70 is at a 90° turn relative to the orientation shown in FIG. 29B. By way of another example, the interface adapter 70 is secured to a stake 14 as shown in FIG. 28C, For comparison, FIGS. 28A and 28B illustrate the light bulb socket interface 12 integrated with the stake, which is not removably coupled thereto.

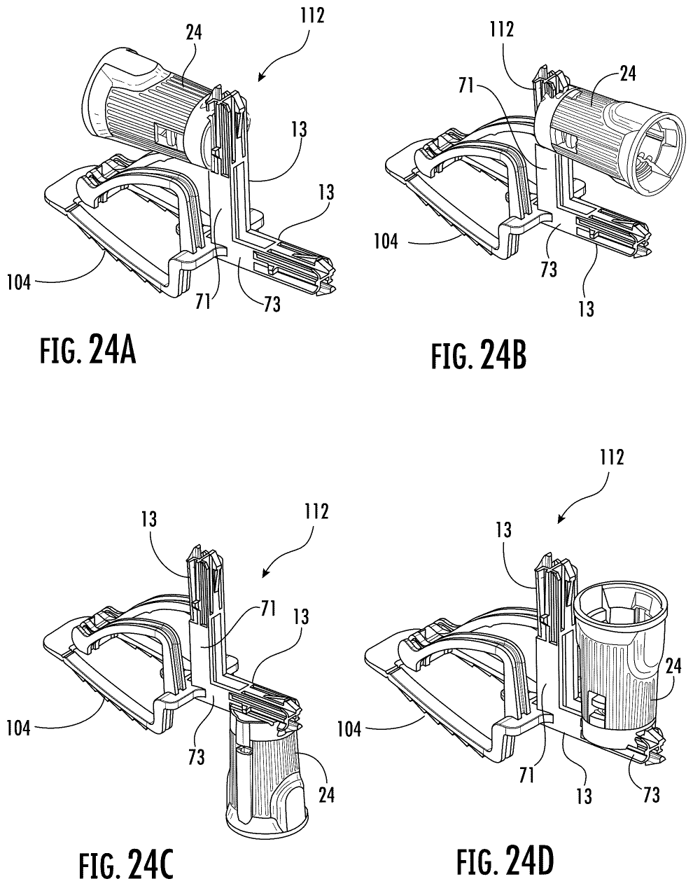

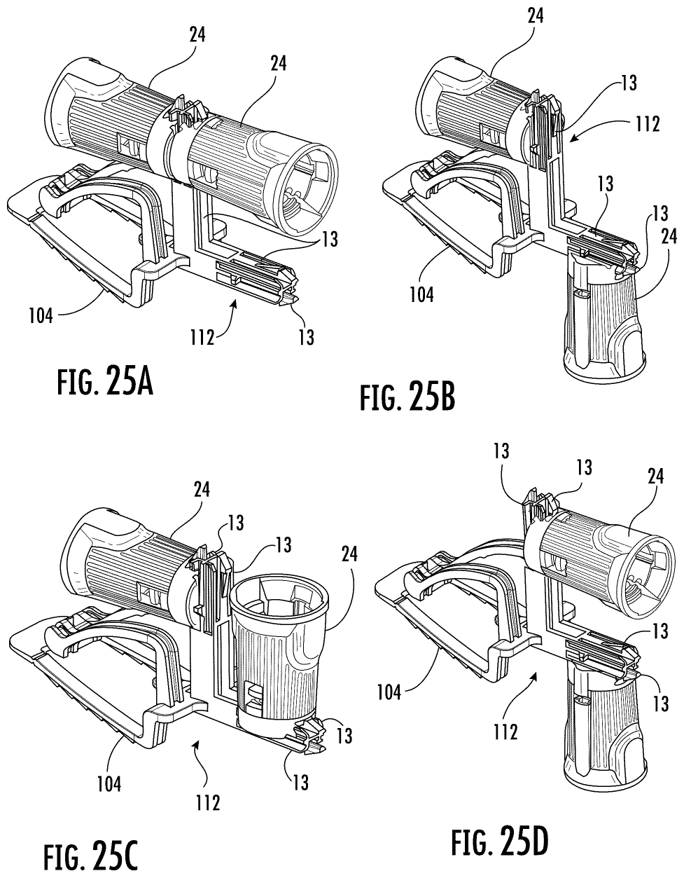

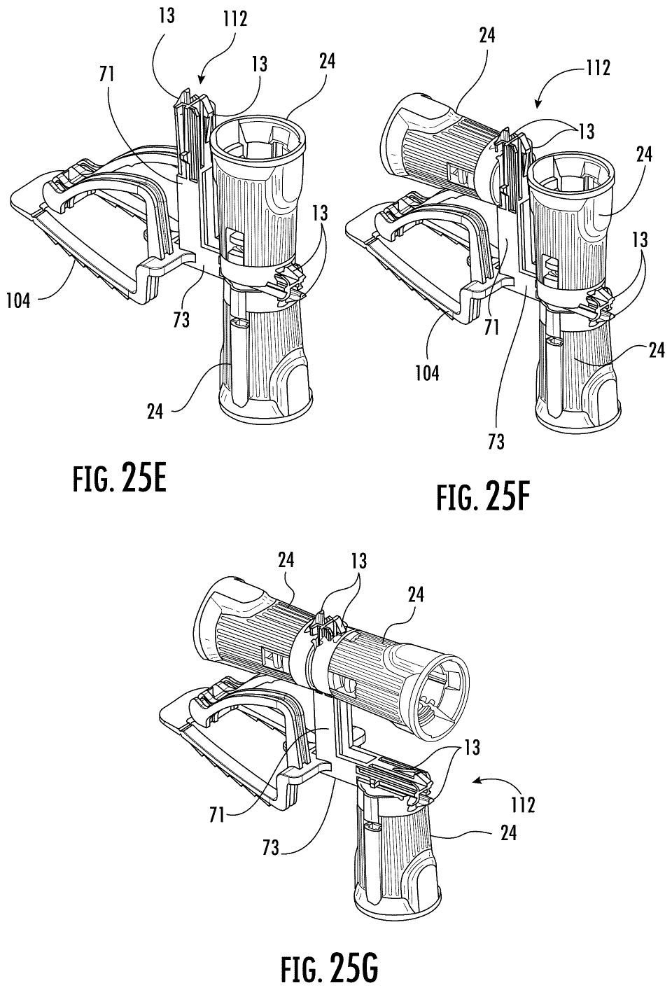

As described above, the light bulb socket support interface 12, comprises one mating interface 13 (FIG. 2, for example), two mating interfaces 13 either secured to support 14 (FIG. 17, for example) or using a socket adapter 50, or four mating interfaces 13 (herein referenced as light bulb socket interface 112) as shown in FIGS. 24A-25G. Moreover, although not shown, the light bulb socket support interface 112 may include three interfaces as is obvious from the drawings. One leg would merely not be double-faced. For example, the light bulb socket support interface 12 shown in FIG. 17 selectively includes an interface on the rear side of the vertical leg 71/73 (not shown) According to the aspect of the invention shown in FIGS. 24A-25G , each leg 71/73 of the light bulb socket support interface 112 or the support adapter 70/70′ is double-faced wherein each side includes an interface for cooperating with light bulb socket 24 or a socket adapter 50.

This aspect of the invention provides additional adaptability of the light bulb support assembly 10 providing additional socket 24 orientation and the ability to support more than one socket 24. More specifically, FIG. 24A illustrates a light bulb socket support assembly 10 including light bulb socket interface 112 mounted to a gutter clip or shingle clip assembly 104 permitting a socket 24 to be oriented in an aft direction. FIG. 24B illustrates the socket 24 facing the fore direction and supported on the vertical leg 71. The double-faced light bulb socket support interface 112 further permits a downwardly facing socket 24 as shown in FIG. 24C while also providing the versatility of supporting an upwardly facing socket 24 as shown in FIG. 24D. As shown herein, the vertical and horizontal legs 71/73 are double-faced or both are one-sided. It is within the scope of the present invention to provide one arm (horizontal or vertical) as one-sided and the other as double-faced. It is also within the scope of the present invention that the support adapter 70/70′ also includes two mating surfaces 13 on both sides of one or both legs 71/73.

FIGS. 25A-25D illustrate benefits of this arrangement and the versatility of the light bulb socket support assembly 10. As shown, the double-faced light bulb socket support interface 112 has four mating surfaces 13 for supporting one-four light bulb sockets 24. FIG. 25A illustrates two sockets 24 supported in the vertical leg and facing opposite directions. FIG. 25B illustrates a socket 24 on each leg, one facing in the aft direction and one facing downward. FIGS. 25C and 25D illustrate different positions of sockets 24. Shown are variations that include two sockets 24, however, three sockets are also envisioned as illustrated in FIGS. 25F-25G.

FIGS. 33A and 33B illustrate the double-faced light bulb socket support interface 112 having four mating surfaces 13 connected to a combination gutter and shingle clip 200. The aspects of the light bulb socket support interface 12 described above (in reference to a one-sided interface) apply to each face of the double-faced light bulb socket support interface 112. As shown in the variations illustrations, the support interface adapter 70 and the light bulb socket interface 112 having multiple mating interfaces 13 are selectively secured to any supporting structure. As is readily apparent, the socket support interface 12, 112 (and if in the form of an adapter 70) supports anywhere from one to even four sockets 24, depending on the socket 24 dimensions and the particular utilization of the light bulb socket support assembly 10.

According to another aspect of the present invention, the combination gutter and shingle clip 200 beneficially provides a support which secures the support assembly 10 including the socket support interface 112 selectively to a roof shingle or a gutter. The clip 200 includes a base 201 and first clamp 205 for securing to the front face of a gutter when the clip 200 is used as a gutter clip. The first clamp 205 comprises at least one, or a pair as shown, of clamp arms 202 and horizontal member 204 extending between the clamp arms 202. A knob 206 extending beneath one or both clamp arms 202 facilitates securing the assembly 10 to smaller gutters. According to another aspect of the present invention, the clamp 200 includes a medial arm 208 having a protrusion 210 on one side and at least one tooth/teeth 212 on the other side. When used as a gutter clip, the protrusion 210 extends over the surface of the gutter and cooperates with the lip of the gutter and facilitates use with various sized gutters. For example, with larger style gutters, the aft end of the first clamp 205 secures to the outside portion of the gutter, in part, because the knob 206 cooperates with the gutter.

When used as a shingle clip, the clip 200 includes the medial arm tooth/teeth 212 and at least one, or a plurality as shown, of teeth 210 on one side of the base 201. The base tooth/teeth 210 and the arm tooth/teeth 212 grip are configured to grip a shingle. The arm teeth 212 slides over the top of the shingle and grips its top side and the teeth 210 mates the underneath side of the shingle and grips its surface. Additionally, the first clamp 205 also extends on the top of the shingle, securing the clip 200 in place. The horizontal member, according to one aspect, includes an irregular bottom surface for gripping purposes when the clip 200 is used as a shingle clip.

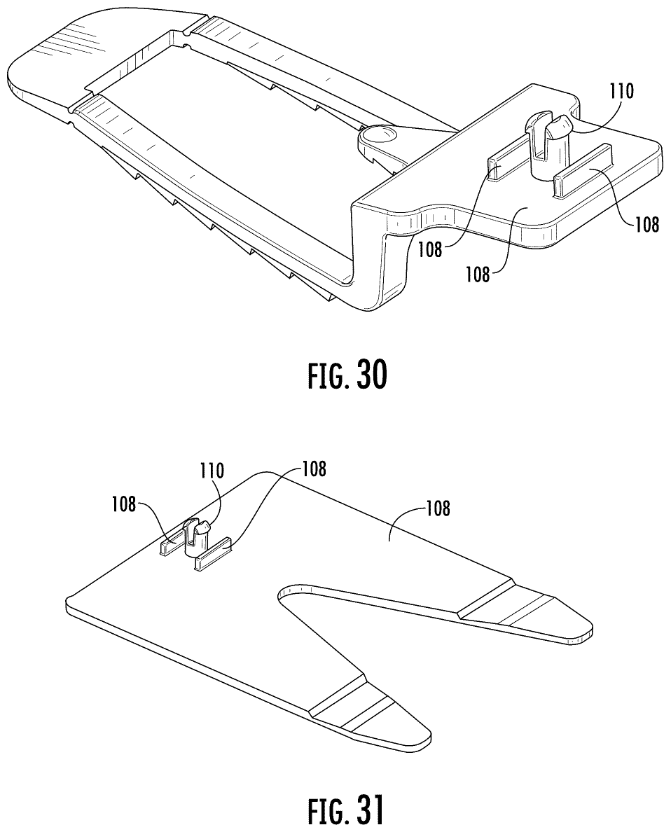

FIGS. 30 and 31 show a support for cooperating with a roof shingle and including an upper surface 108 to cooperate with the light bulb socket interface 12, 112 disclosed herein. A post 110 extends from the upper surface 108 to cooperate, for example, with the aperture 98 shown in FIGS. 26A-26C and FIGS. 32A and 32B. Similarly, a post 110 is also provided on a stake 14 as shown in FIG. 28D for cooperating with hole 72 of the support adapter 70. At least one or a pair as shown, of flanges 106 prevent unintentional rotation on the post 110.

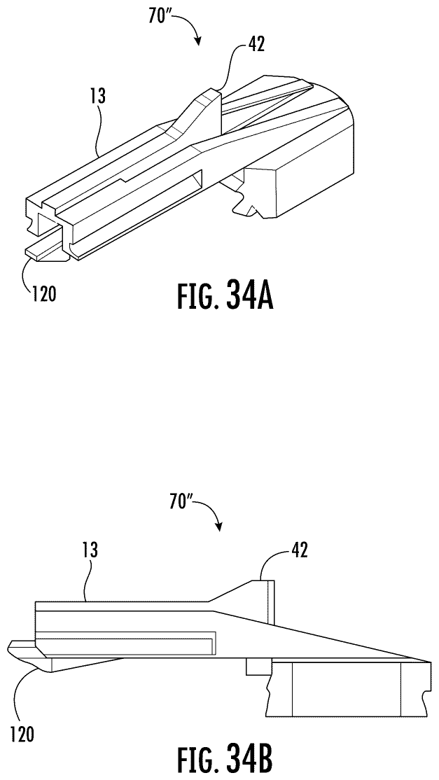

FIGS. 34A and 34B illustrate a support adapter 70″ according to another aspect of the present invention which, in effect, inverts the mating surface such as to “hang” a light in an inverted position. The support adapter 70″ provides for a connection to a support enabling the light bulb socket 24 or the socket adapter 50 to hang or be suspended from the support. As shown, the support adapter includes a single mating surface defining its light bulb socket support interface 12. The lock 120 shown in FIGS. 34A and 34B is akin to the locking member 36 described above, albeit it is inverted. When a socket or socket adapter is applied to the bottom facing mating interface 12, it is at least inconvenient to access the lock 120 to disengage the lock 120. Therefore, a release 42 is provided to disengage the support adapter 70′. For example, lock 42 is released to release the support adapter 70″ (because it is impractical to access the lock 120)

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the invention described.

What is claimed is:

1. A support assembly for cooperating with a light bulb having a light strand and light bulb socket, said support assembly comprising:
a light bulb socket interface for cooperating with the light bulb socket, said light bulb socket interface having a mating interface comprising:
a platform having a fore end and an aft end and a longitudinal axis; and
a pair of flanges extending upwardly from said platform generally parallel to the longitudinal axis and substantially between said platform fore end and said platform aft end wherein said pair of flanges are each defined by a base portion extending from said platform and a rail portion extending from said base portion wherein said rail portion extends outwardly from said base portion, generally perpendicular to said longitudinal axis, so as to define an interface receiving cavity and at least one of said pair of flanges defines an aft stop defining an aft end of said interface receiving cavity.

2. The support assembly according to claim 1 wherein said pair of flanges define a channel therebetween and said mating interface further comprises a locking member having a fore end, said locking member extending within said channel and extending from an aft end of said channel wherein said locking member is moveable from a first position extending generally parallel to said rail portion of each of said pair of flanges to a second position which is depressed within said channel wherein said locking member fore end extends downward from said first position, wherein application of the light bulb socket engages said pair of flanges adjacent said platform fore end and depresses said locking member to move said locking member from said first position to said second position, and said interface receiving cavity is configured to receive the light bulb socket when it is moved in an aft direction.

3. The support assembly according to claim 2 wherein said locking member includes a lock extending upwardly from said locking member adjacent said locking member fore end.

4. The support assembly according to claim 3 wherein said lock comprises an aft end defining a contact surface for cooperating with the light bulb socket when said light bulb socket has been applied to said light bulb socket interface wherein said locking member is moved from said first position to said second position when said locking member is released.

5. The support assembly according to claim 4 wherein said lock defines a sloped lock fore end which slopes upward from said locking member fore end and said lock aft end extends generally perpendicular to said locking member defining a contact surface.

6. The support assembly according to claim 1 further comprising a support.

7. The support assembly according to claim 6 wherein said light bulb socket interface is mounted to said support wherein said support positions the light bulb in a desired position.

8. The support assembly according to claim 7 wherein said support is a stake.

9. The support assembly according to claim 7 wherein said support is a shingle clip.

10. The support assembly according to claim 1 wherein said support assembly further comprises a socket adapter having a first face and a second face wherein said first face defines a light bulb socket receiving cavity including a socket seat and at least one side arm for receiving the light bulb socket and wherein said at least one side arm defines an opening for receipt of the light strand and said second face is configured to cooperate with said light bulb socket interface.

11. The support assembly according to claim 10 wherein said at least one side arm extends from said socket seat and includes a clip defining said opening configured for receipt of the light strand.

12. The support assembly according to claim 10 wherein said socket adapter comprises a pair of said at least one side arms, each positioned on an opposing side edge of said socket adapter and each defining said opening wherein said openings of said pair of said side arms face different directions.

13. The support assembly according to claim 10 wherein said socket adapter second face defines a light bulb socket mating member configured to cooperate with said light bulb socket interface.

14. The support assembly according to claim 2 wherein said locking member of said mating interface extends across said platform in a first direction and said light bulb socket interface includes a bottom surface, opposite said platform which defines a channel extending across said bottom surface in a second direction wherein said second direction is angularly oriented relative to said first direction.

15. The support assembly according to claim 6 wherein said light bulb socket interface is indirectly mounted to said support wherein said support assembly further comprises a support adapter including said mating interface and connects to said support.

16. The support assembly according to claim 15 wherein said light bulb socket interface includes a securing member for securing said support adapter to said support.

17. The support assembly according to claim 15 wherein said support adapter includes a first leg and a second leg oriented to said first leg at a predetermined angle.

18. The support assembly according to claim 17 wherein said angle is generally 90 degrees.

19. The support assembly according to claim 17 wherein one of said first and second legs include said mating interface.

20. The support assembly according to claim 19 wherein said first leg and said second leg each include said mating interface.

21. The support assembly according to claim 19 wherein said support adapter includes at least a first aperture defined by at least one of said first and second legs, said first aperture extending generally perpendicular to said at least one of said first and second legs.

22. The support assembly according to claim 18 wherein said support adapter includes at least a second aperture defined by at least one of said first and second legs, said second aperture extending generally parallel to said at least one of said first and second legs and configured for receiving a connection member for securing said support adapter to said support.

23. The support assembly according to claim 19 wherein said support adapter includes, between said first and second legs, on each side thereof, a pair of perpendicular members and an arm extending between said pair of perpendicular members for connecting said first and second legs and for defining an aperture configured for receipt of a securing member for securing said support adapter to a support.

24. The support assembly according to claim 19 wherein said first and second leg each include said mating interface.

25. The support assembly according to claim 19 wherein at least one of said first and second legs of said support adapter defines a channel extending parallel to said at least one of said first and second legs, said channel extending along and behind said light bulb socket interface and configured for receipt of a securing member for securing said support adapter to said support.

26. The support assembly according to claim 1 wherein said light bulb socket interface includes a first leg and a second leg oriented to said first leg at a predetermined angle and wherein said first leg and said second leg each include said mating interface and wherein said first leg is removably connected to said second leg.

27. The support assembly according to claim 1 wherein said light bulb socket interface includes a first leg and a second leg oriented to said first leg at a predetermined angle and wherein said first leg and said second leg each include said mating interface and said first leg is pivotally connected to said second leg.

28. The support assembly according to claim 1 wherein said light bulb socket interface includes a first leg and a second leg oriented to said first leg at a predetermined angle, wherein at least one of said first and second legs includes two of said mating interfaces on opposing sides thereof.

29. The support assembly according to claim 28 wherein said pair of flanges define a channel therebetween and said mating interface further comprises a locking member having a fore end, said locking member extending within said channel and extending from an aft end of said channel wherein said locking member is moveable from a first position extending generally parallel to said rail portion of each of said pair of flanges to a second position which is depressed within said channel wherein said locking member fore end extends downward from said first position, wherein application of the light bulb socket engages said pair of flanges adjacent said platform fore end and depresses said locking member to move said locking member from said first position to said second position, and said interface receiving cavity is configured to receive the light bulb socket when it is moved in an aft direction.

30. The support assembly according to claim 29 wherein said lock comprises an aft end defining a contact surface for cooperating with the light bulb socket when said light bulb socket has been applied to said light bulb socket interface wherein said locking member is moved from said second position to said first position to secure the light bulb socket on said light bulb socket interface.

31. The support assembly according to claim 30 wherein said lock defines a sloped lock fore end which slopes upward from said locking member fore end and said lock aft end extends generally perpendicular to said lock fore end defining a contact surface.

32. The support assembly according to claim 28 wherein said first and second legs include two of said mating interfaces on opposing sides thereof.

33. The support assembly according to claim 6 wherein said support includes a post and said platform of said mating interface defines an aperture configured for receipt of said post.

34. The support assembly according to claim 33 wherein said platform further includes at least one flange extending therefrom parallel to said longitudinal axis and adjacent said post for limiting rotational movement of said light bulb socket interface on said support.

35. The support assembly according to claim 2 wherein at least one of said pair of flanges includes a stop extending outwardly therefrom.

36. A socket adapter for cooperating with a light bulb having a light strand and light bulb socket, said socket adapter for use with a light bulb socket interface wherein the light bulb socket interface includes a mating interface, said adapter comprising:
a first face and a second face wherein said first face defines a light bulb socket receiving cavity including a socket seat and at least one side arm for receiving the light bulb socket and wherein said at least one side arm defines an opening for receipt of the light strand and said second face is configured to cooperate with said light bulb socket interface.

37. A support assembly for supporting a light bulb having a light strand and light bulb socket to an architectural structure, said assembly further comprising:
a light bulb socket interface for cooperating with the light bulb socket; and
a clip comprising a base connected to said light bulb socket interface, a first clamp having at least one clamp arm and a knob extending downwardly from said at least on clamp arm, and a medial arm extending between said first clamp and said base, said medial arm including a protrusion extending upwardly therefrom, facing said first clamp.
